(19) United States
(12) Patent Application Publication
(10) Pub. No.: US 2015/0240997 A1
(43) Pub. Date: Aug. 27, 2015

(54) PRESSURIZED FLUID CONTAINER AND METHOD FOR THE PRODUCTION THEREOF

(71) Applicant: L'Air Liquide, Société Anonyme pour I'Etude et I'Exploitation des Procédés George Claude, Paris (FR)

(72) Inventors: Haithem Azizi, Alfortville (FR); Hervé Barthelemy, Montevrain (FR); Emmanuel Baune, Saint Prix (FR)

(21) Appl. No.: 14/422,856

(22) PCT Filed: Jun. 24, 2013
(86) PCT No.: PCT/FR2013/051463

§ 371 Date: Feb. 20, 2015

(30) Foreign Application Priority Data
Sep. 5, 2012 (FR) 1258261

(51) Int. Cl. F17C 13/08; F17C 1/16

(52) U.S. Cl. CPC F17C 13/084; F17C 1/16; F17C 2203/011; F17C 2203/0646; F17C 2203/0648; F17C 2205/018; F17C 2209/227

(57) ABSTRACT

The invention relates to a pressurised fluid container, in particular a pressurised gas cylinder, comprising a body (1) forming a sealed storage volume for the fluid. According to the invention, a first end of the body (1) comprises an opening (2), while a second end of the body (1) comprises a base (3) secured to the body (1). The body (1) is formed by a metal material, a metal alloy or aluminium. The container is characterised in that the base (3) comprises a metal material, a metal alloy or an aluminium alloy having an electronegativity on the Pauling scale that is greater than that of the material forming the body (1). The invention also relates to a method for the production of such a container.

### CROSS REFERENCE TO RELATED APPLICATIONS

This application is a 371 of International PCT Application PCT/FR2013/051463 filed Jun. 24, 2013, which claims priority to French Patent Application No. 1258261 filed Sep. 5, 2012, the entire contents of which are incorporated herein by reference.

### BACKGROUND

The present invention relates to a pressurized fluid container and the process for the fabrication thereof.

The invention relates more particularly to a pressurized fluid container, in particular a pressurized gas cylinder, comprising a body forming a leaktight storage volume for fluid, a first end of the body comprising an orifice, a second end of the body comprising a foot attached to the body, the body being composed of a metallic material, of a metal alloy or of aluminum.

Pressurized gas containers or cylinders are subjected to standards such as international standard ISO 9809. These high-pressure containers (normally for pressures greater than 60 bar) are said to be “seamless” since their construction is based on the shaping, usually by hot pressing, of a sheet or billet or tube for obtaining a “monolithic” container. Recourse to welding for obtaining the container is indeed not permitted over the whole of its surface for this type of construction.

Depending on the design of the container, the base of the container may be of concave or convex shape. The convex base geometry may enable the production of a container that is comparatively lighter than a concave-based container of the same storage volume. A container suitable for being carried, transported or moved by a user often needs to be placed in a vertical position. Thus, a convex-based container must therefore be generally equipped with a foot, attached to its base, in order to enable the vertical support thereof.

Such a foot must make it possible to avoid in particular external stresses (impacts, friction, etc.). This is because these mechanical stresses may damage the external coating of the container and result in corrosion problems. The foot must also have a shape that prevents the stagnation of water or moisture which are aggravating corrosive factors. Indeed, the joining of a foot to a container may result in infiltrations of water or moisture between the body of the container and the foot. This embrittlement factor may have serious consequences in terms of safety.

In order to minimize this risk, it is known to carry out a check of the possible corrosion of the container before each filling thereof. This may be carried out, for example, by removing the foot and carrying out a visual inspection. However this requires a process that is onerous and expensive on an industrial scale.

### SUMMARY

One objective of the present invention is to overcome all or some of the drawbacks of the prior art raised above.

For this purpose, the container according to the invention, furthermore in accordance with the generic definition given in the preamble above, is essentially characterized in that the foot comprises a metallic material, a metal alloy or an aluminum alloy having an electronegativity according to the Pauling scale greater than the electronegativity of the material making up the body.

Furthermore, embodiments of the invention may comprise one or more of the following characteristics:

the body consists of steel having an electronegativity according to the Pauling scale of between 1.7 and 2, the foot comprising a material having an electronegativity according to the Pauling scale of between 1.2 and 1.6;

the foot is composed of at least one of the following materials: an aluminum alloy, zinc or magnesium;

the body is composed of aluminum, of an aluminum alloy or of titanium and in that the foot is composed of magnesium;

the foot is composed of plastic coated with a metallic material, a metal alloy or aluminum having an electronegativity according to the Pauling scale of greater than the electronegativity of the material making up the body;

the foot (3) is attached to the body by adhesive bonding;

the second end of the body is convex, the foot being adhesively bonded over 5% to 25%, and preferably 10% to 15% of the surface area of the second convex end of the body;

the foot comprises a flared upper end which converges in the direction of the second end of the body;

the foot comprises a lower end folded back toward the central part of the foot;

the second end of the body is at least partly housed in a volume delimited by the foot, the foot having a mass of between 20% and 50% of the mass of the portion of the second end of the body covered by the foot.

The invention may also relate to any alternative device or process comprising any combination of the characteristics above or below.

The invention also relates to a process for fabricating a pressurized fluid container, in particular a pressurized gas cylinder, from a body made of a metallic material, of a metal alloy or of aluminum, the body forming a leaktight storage volume for fluid and being provided with an orifice located at a first end, the process comprising a step of attaching, to a second end of the body, a foot comprising a metallic material, a metal alloy or an aluminum alloy having an electronegativity according to the Pauling scale greater than the electronegativity of the material making up the body.

According to other possible distinctive features:

the foot is attached to the body by adhesive bonding;

the foot and the body are painted before or after the adhesive bonding of the foot to the body.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 represents a schematic and partial cross-sectional view, illustrating an example of a gas container according to the invention,

FIGS. 2 to 5 represent perspective and schematic views respectively illustrating four possible embodiments of feet for a fluid container according to the invention,

FIG. 6 represents a perspective and vertical cross-sectional view of the foot from FIG. 5.

### DETAILED DESCRIPTION OF PREFERRED EMBODIMENTS

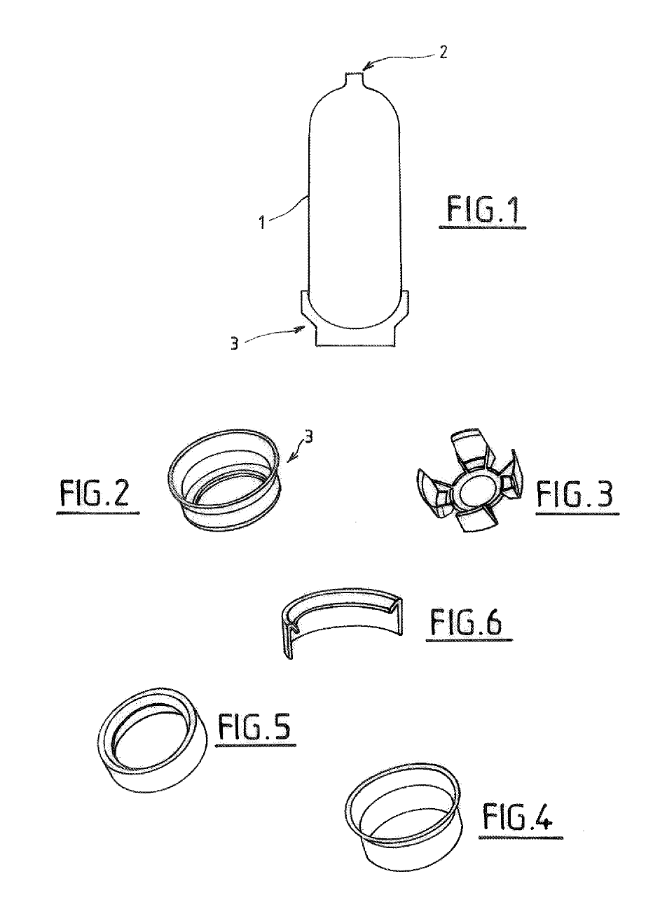

FIG. 1 schematically represents a pressurized fluid container, in particular a pressurized gas cylinder. This container comprises a body 1, for example which is cylindrical, forming a leaktight storage volume for fluid. A first shoulder-shaped end of the body 1 comprises an orifice 2 intended to receive for example a valve. A second end of the body 1 is convex and comprises a foot attached to the body 1. Conventionally, the body 1 is composed of or consists of a metallic material, a metal alloy or aluminium.

According to one advantageous distinctive feature, the foot 3 comprises or consists of a metallic material, a metal alloy or an aluminum alloy having an electronegativity according to the Pauling scale greater than the electronegativity of the material making up the body 1.

In this way, the foot 3 acts with respect to the body 1 as an anode which is corroded as a priority, thus protecting the body 1 of the container from possible risks of corrosion. Specifically, in the event of the presence of aggressive liquid such as water, the most electronegative metal will be corroded while the most electropositive metal will be protected according to the principle of galvanic protection.

For example, if the body 1 of the container is made of steel having an electronegativity (EN) of 1.8 according to the Pauling scale, the foot 3 may be chosen preferably to be made of an aluminum alloy (electronegativity EN=1.6), or of any other element or alloy that is more electronegative than the steel (according to the Pauling scale for example), such as for example zinc (EN=1.6) or magnesium (EN=1.3).

In the case where the body 1 of the container is made of aluminum (EN=1.6), the foot 3 may be composed of magnesium (EN=1.3). In the case where the body of the container is made of titanium (EN=1.5), the foot 3 may be composed of magnesium (EN=1.3).

According to one possible variant, the foot 3 may be obtained by a plastic molding or injection technique. In this case, the cathodic protection of the body 1 of the container may be obtained by carrying out, on the plastic foot 3, a treatment that forms a coating on its plastic surface (for example a metallization using zinc or any other suitable material having an electronegativity greater than the electronegativity of the material of the body 1).

Preferably, the foot 3 is adhesively bonded to the body 1. This adhesive bonding may be carried out for example by using an epoxy adhesive or a one- or two-component adhesive or an adhesive based on methyl methacrylate or based on polyurethane that can be thermally crosslinked or crosslinked at room temperature.

A first example of fabrication of the container may comprise the following steps:

a step of producing the body by shaping sheeting in order to produce a first shoulder-shaped end (first end), and a base (second end) according to given thicknesses,

a step of adhesively bonding the foot 3 to the body 1 of the container (with, where appropriate, adjustment of a member for holding the foot on the container),

a step of painting the assembly of the body 1 equipped with its foot 3 (for example by means of an electrostatic powder),

a step of drying the assembly in order to carry out the crosslinking of the adhesive and the drying of the paint.

In a second example, the fabrication process differs from that above only in that the body 1 and the foot 3 are painted before the adhesive bonding thereof and are adhesively bonded after the drying of the paint.

The first fabrication example enables drying of the paint at the same time as the crosslinking of the adhesive. The second fabrication example could in particular be used in the case where the crosslinking of the adhesive and the drying of the paint cannot be obtained with the same final temperature cycle.

Preferably, the temperature at which the adhesive degrades is below the temperature at which the coat of paint degrades, in order to allow maintenance of the foot without adversely affecting the layer of paint.

Preferably, the foot 3 has a shape designed so that the impact resistance and resistance to other mechanical stresses on the foot 3 are minimized. In this way, the mechanical stresses on the adhesive, the risks of deformations of the foot (rigidity) and the risk of detachment of the foot are minimized.

Preferably, the foot 3 has a surface area to be adhesively bonded that is at least equal to 5%, preferably greater than 15% of the surface area of the base of the body 1 to which it is adhesively bonded.

As illustrated schematically in FIG. 2, preferably the foot 3 may have the general shape of a crown, the upper end of which is flared upwards in order to be adhesively bonded in particular to the convex part of the end of the body 1. The lower end of the foot 3 forms an inward flange of the foot 3 and thus defines a flat base for stable support of the container. This folded-back lower end of the foot 3 limits the risks of creation of a sharp and abrasive edge that is dangerous for a user.

The exemplary embodiment of FIG. 4 differs from that of FIG. 2 only in that the lower end of the foot 3 does not form an inward flange of the foot 3. That is to say that the container rests on a lower circular edge of the foot 3.

In the exemplary embodiment of FIG. 3, the foot 3 comprises four bearing plates perpendicularly connected to a circular base. The four bearing plates may be adhesively bonded to the end of the body 1 while the circular base, which is flat, enables the stable vertical support of the container.

In the exemplary embodiment of FIGS. 5 and 6, the foot has the shape of a cylindrical tube, the upper end of which forms a downward- and inward-turned flange of the foot (cf. the cutaway view of FIG. 6). The flange is intended to be adhesively bonded to the end of the body 1. The container resting on the ground via the lower circular edge.

The abrasion resistance of the foot 3 (scraping on the ground for example) is minimized owing to the above geometries.

Preferably, the mass of the foot 3 is less than 50% of the equivalent mass of the portion of the base of the body 1 to which the foot is attached.

The foot 3 may be obtained by an industrial process of mechanical shaping, preferably by a technique of pressing or mechanical spinning or smelting or welding of metal parts.

According to other possible variants, the foot 3 may be attached magnetically to the body 1, for example via one or more magnets mounted, adhesively bonded or banded to the foot 3.

It is easily understood that while being of simple and inexpensive structure, the invention makes it possible to produce a container that does not require the same surveillance measures of its corrosion as according to the prior art. Indeed, any corrosion would be induced on the foot 3 and would not present a safety risk for the pressurized container. Such corrosion may thus be confined to the foot 3 and may be tolerated.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-13. (canceled)

14. A pressurized fluid container, comprising a body forming a leak-tight storage volume for fluid, a first end of the body comprising an orifice, a second end of the body comprising a foot attached to the body, the body being composed of a metallic material, of a metal alloy or of aluminum, the foot comprising a metallic material, a metal alloy or an aluminum alloy having an electro-negativity according to the Pauling scale greater than the electro-negativity of the material making up the body, wherein the foot is attached to the body by adhesive bonding.

15. The container of claim 14, wherein the body consists of steel having an electro-negativity according to the Pauling scale of between 1.7 and 2 and in that the foot comprises a material having an electro-negativity according to the Pauling scale of between 1.2 and 1.6.

16. The container of claim 15, wherein the foot is composed of at least one of the following materials: an aluminum alloy, zinc or magnesium.

17. The container of claim 14, wherein that the foot is composed of magnesium.

18. The container of claim 14, wherein the foot is composed of plastic coated with a metallic material, a metal alloy or aluminum having an electro-negativity according to the Pauling scale of greater than the electro-negativity of the material making up the body.

19. The container of claim 14, wherein the second end of the body is convex and in that the foot is adhesively bonded over 5% to 25% of the surface area of the second convex end of the body.

20. The container of claim 14, wherein the foot comprises a flared upper end which converges in the direction of the second end of the body.

21. The container of claim 14, wherein the foot comprises a lower end folded back toward the central part of the foot.

22. The container of claim 14, wherein the second end of the body is at least partly housed in a volume delimited by the foot and in that the foot has a mass of between 20% and 50% of the mass of the portion of the second end of the body covered by the foot.

23. The container of claim 14, wherein the second end of the body is at least partly housed in a volume delimited by the foot and in that the foot has a mass of between 20% and 50% of the mass of the portion of the second end of the body covered by the foot.

24. The container of claim 23, wherein the foot and the convex second end of the body have relative masses so that the foot has a mass of between 20% and 50% of the mass of the second end.

25. A process for fabricating a pressurized fluid container, from a body made of a metallic material, of a metal alloy or of aluminum, the body forming a leak-tight storage volume for fluid and being provided with an orifice located at a first end, the process comprising a step of attaching, to a second end of the body, a foot comprising a metallic material, a metal alloy or an aluminum alloy having an electro-negativity according to the Pauling scale greater than the electro-negativity of the material making up the body, and in that the foot is attached to the body by adhesive bonding.

26. The process of claim 25, wherein the foot and the body are painted before or after the adhesive bonding of the foot to the body.
